(19) United States
(12) Patent Application Publication
(10) Pub. No.: US 2024/0355493 A1
(43) Pub. Date: Oct. 24, 2024

(54) METHOD FOR LOAD-DEPENDENT UNLOADING AND/OR LOADING OF A FUEL ELEMENT OUT OF AND INTO A FUEL ELEMENT CONTAINER

(71) Applicant: Kernkraftwerk Gösgen-Däniken AG, Däniken (CH)

(72) Inventors: Christian LEDERMANN, Laupersdorf (CH); Bruno ZIMMERMANN, Erlinsbach (CH)

(21) Appl. No.: 18/580,847

(22) PCT Filed: Jul. 19, 2022
(86) PCT No.: PCT/EP2022/070183

§ 371 Date: Jan. 19, 2024

(30) Foreign Application Priority Data
Jul. 22, 2021 (EP) 21187279.1

(51) Int. Cl. G21C 19/10; G05D 15/01

(52) U.S. Cl. CPC G21C 19/10; G05D 15/01

(57) ABSTRACT

The present invention relates to a method for load-dependent unloading and/or loading of a fuel element out of and into a fuel element container, especially a reactor pressure vessel, by means of a loading device. The loading device is designed to lift a fuel element out of the fuel element container or to lower it into the fuel element container along a path of travel at a variable speed of travel. The loading device has a load-measuring device for online measurement of a dynamic load and/or load change acting at the time on the loading device along the path of travel during lifting or lowering of the fuel element, the speed of travel during lifting or lowering of the fuel element being subject to closed-loop control in dependence upon the load and/or load change being measured at the time.

The present invention relates to a method for load-dependent unloading and/or loading of a fuel element from or into a fuel element container, for example from or into a reactor pressure vessel.

In nuclear power plants, fuel elements are exchanged at regular intervals between operating cycles of a nuclear reactor for the purpose of inspection. For that purpose, the fuel elements must be loaded and unloaded from a reactor pressure vessel using a suitable loading device. The fuel elements typically stand upright in the reactor pressure vessel at a small distance apart from one another. During loading and unloading, the relevant fuel element is lifted out of the reactor pressure vessel and lowered into its designated position in the reactor pressure vessel by means of the loading device. For that purpose, a gripper of the loading device grasps the fuel element at its upper end and the fuel element is removed or introduced vertically from or into the reactor pressure vessel.

The fuel elements themselves consist of assemblies of fuel rods which are held together in the assembly by means of suitable spacers. The purpose of the spacers is to ensure that the individual fuel rods are clamped in place, are positioned at the correct distance apart from one another and do not become distorted. Due to the conditions in the reactor pressure vessel, especially due to radiation-induced creep under the thermohydraulic forces and temperatures prevailing in the reactor pressure vessel, the fuel elements may nevertheless be subject to deformation—such as bowing and twisting. In combination with the design of the spacers, this can have the result that the fuel elements, due to their being a small distance apart, touch or become snagged on the spacers during loading and/or unloading, which in turn can lead to damage to the fuel elements.

Apart from in reactor pressure vessels, in principle similar problems can also arise during loading and unloading of fuel elements into and from other fuel element containers, for example in fuel element compact storage facilities, wet storage facilities, transport containers, or transport and storage containers. Apart from the reactor pressure vessel it is also possible for the other mentioned containers to have a fuel element rack or a fuel element basket. Hereinbelow the term “fuel element container” is therefore employed as a general term for such containers in which the present invention can be used.

In order to avoid such damage, the fuel rods are therefore usually lowered into the fuel element container or lifted out of the fuel element container at a low speed which is adjusted manually by the operator of the relevant loading device, this being associated with a correspondingly large amount of time.

The problem of the present invention is therefore to provide a method for unloading and/or loading one or more fuel elements from or into a fuel element container which makes it possible to reduce the risk of damage to the fuel elements during the loading and unloading operations, to relieve the workload on the operator and at the same time to reduce the amount of time required for unloading and loading.

In accordance with the present invention, that problem is solved by a method according to independent claim 1. Advantageous embodiments of the method according to the invention are subject matter of the dependent claims.

According to the invention, a method is proposed which serves for load-dependent unloading and/or loading of one or more fuel elements from or into a fuel element container, especially from or into a reactor pressure vessel, by means of a loading device. The loading device is designed to lift a fuel element out of the fuel element container or to lower it into the fuel element container along a path of travel at a variable speed of travel. The path of travel is preferably rectilinear, especially substantially exclusively vertically rectilinear, in the region of the fuel element container. The loading device has a load-measuring device for online measurement of a dynamic load and/or load change acting at the time on the loading device along the path of travel during lifting or lowering of the fuel element. In accordance with the method according to the invention, the speed of travel during lifting or lowering of the fuel element is subject to closed-loop control in dependence upon the load and/or load change being measured at the time.

As mentioned at the beginning, in the context of the present invention the fuel element container can be inter alia a reactor pressure vessel, a fuel element compact storage facility, a wet storage facility, a transport container, or a transport and storage container. Apart from the reactor pressure vessel it is also possible for the other mentioned containers to have a fuel element rack or a fuel element basket. In the case of the last-mentioned “containers”, the method according to the invention can also be used for monitoring the ageing of the fuel element racks, baskets or containers.

The path of travel in a region in which the fuel element to be lifted or lowered is still located next to other fuel elements present in the fuel element container, especially the path of travel in the region of the fuel element container, that is to say the path of travel while the fuel element to be lifted or lowered is located in the fuel element container, is preferably rectilinear, especially exclusively rectilinear, especially preferably substantially vertically rectilinear, very especially preferably exclusively substantially vertically rectilinear. “Exclusively rectilinear” is understood as being a path of travel without sideways displacement, that is to say a displacement-free path of travel. Accordingly, “exclusively substantially vertically rectilinear” is understood as being a vertical path of travel without horizontal displacement, that is to say a vertically displacement-free path of travel.

In particular, the above-mentioned path of travel can preferably relate exclusively to the path of travel in a region in which the fuel element to be lifted or lowered is still located next to other fuel elements present in the fuel element container, especially to the path of travel in the region of the fuel element container, that is to say the path of travel while the fuel element to be lifted or lowered is located in the fuel element container.

According to the invention it has been recognised that certain problems during the loading and unloading operation have a direct effect on the dynamic load or load change, which can be detected instantaneously by online measurement of the dynamic load and/or load change, and that, furthermore, by adjusting the speed of travel during the lifting and lowering of the fuel element to the load and/or load change being measured at the time, it is possible to avoid potential damage to the fuel element. In the context of the present invention, a load change is understood as being an increase or decrease over time in the dynamic load acting on the loading device along the path of travel during the lifting or lowering of the fuel element. In particular, it can be a load gradient. As described at the beginning, during lifting or lowering deformation or bowing of the fuel elements can lead to slowly increasing friction between the fuel element to be lifted or lowered and parts of the fuel element container and/or one or more adjacent fuel elements located in the fuel element container. This results in an increased load during the lifting or a reduced load during the lowering. Furthermore, as a result of the deformation/bowing of the fuel elements, rapidly increasing load peaks can sometimes occur along the path of travel, namely especially where one or more spacers of the fuel element to be lifted or lowered, which spacers hold the fuel rods forming the fuel element in position in the fuel element, are located side by side with one or more spacers of one or more adjacent fuel elements located in the fuel element container at substantially the same height along the path of travel and slide over one another. The load peaks resulting from the spacers' sliding over one another have frequently been correlated with a previously slowly increasing load during lifting or slowly decreasing load during lowering, because they originate from the same cause. In such cases it is possible to detect rapidly increasing load peaks in good time by online measurement of the previously slowly increasing load during lifting or slowly decreasing load during lowering and accordingly reduce the speed of travel during lifting or lowering of the fuel elements in dependence upon the load or load change being measured at the time in order thus to reduce the risk of damage to the fuel elements. Furthermore, the reduction in the speed of travel allows the lifting or lowering movement to be stopped more quickly, for example should the load exceed a predefined maximum load during the lifting or fall below a predefined minimum load during the lowering.

In particular, automatic adjustment by means of closed-loop control via a feedback loop has proved advantageous here. In the case where the loading device is controlled by an operator, the method according to the invention relieves the operator's workload. In comparison with the previously exclusively manual control by the operator without online measurement of the dynamic load and/or load change, automatic closed-loop control of the speed of travel in dependence upon the dynamic load and/or load change makes it possible to react more quickly to any problems during the loading and unloading operation. This is especially true—as described above—in the case of moderately increasing dynamic loads or in the case of moderate load changes which allow the closed-loop control to reduce the speed of travel in good time. Because the speed of travel during the lifting or lowering of the fuel element is subject to closed-loop control in dependence upon the load and/or load change being measured at the time, the time required for unloading and/or loading a fuel element from or into a fuel element container is consequently significantly reduced. This time-saving during unloading and loading can profitably reduce, for example, the time required for inspection of a nuclear power plant.

A (dynamic) load in the context of the present invention is understood as being the total load acting on the loading device during lifting and lowering, which is detected as a total weight force by the load-measuring device. The total load or total weight force is composed, on the one hand, of the basic load and, on the other hand, of any forces due to friction (due to touching) and/or snagging of the fuel elements during lifting or lowering. The basic load corresponds to the weight force that corresponds to the mass of the fuel element to be lifted or lowered and the mass of the parts of the loading device located between load-measuring device and fuel element. Those parts can include, for example, a gripper of the loading device. The mass of a centring bell, which may be present for centring the fuel elements on a predefined position during loading and unloading, can preferably be disregarded as part of the loading device in the determination of the basic load if, during the determination of the basic load, it is supported on a side stop, on a part of the fuel element container (for example the fuel element rack in the case of fuel element pools) or on adjacent fuel elements in the fuel element container (for example in the case of reactor pressure vessels). This is usually the case during the lowering and lifting of a fuel element out of the fuel element container during the critical phase in which friction (due to touching) or snagging could occur. Only once the fuel element has been fully lifted out of the problematic region is the centring bell in this configuration also lifted and it would then be taken into account, in respect of its mass, as part of the loading device in the determination of the basic load. If no friction (due to touching) or no snagging occurs during the lifting or lowering, the dynamic load acting on the loading device and measured by the load-measuring device corresponds substantially to the basic load, that is to say the weight force that corresponds to the mass of the fuel element to be lifted or lowered and the mass of the parts of the loading device located between load-measuring device and fuel element. If friction (due to touching) and/or snagging occurs during the lifting, the dynamic load acting on the loading device and measured by the load-measuring device increases above the basic load by substantially the value of the forces caused by friction and/or snagging. Conversely, if friction (due to touching) and/or snagging occurs during the lowering, the dynamic load acting on the loading device and measured by the load-measuring device falls below the basic load by substantially the value of the forces caused by friction and snagging. The basic load can preferably be determined by means of the load-measuring device of the loading device, for example prior to the lowering of the fuel element into the fuel element container or on pick-up of the fuel element at the beginning of the lifting movement.

In accordance with an advantageous configuration of the invention, the loading device can accordingly be designed to determine the basic load, for example by determination of the load acting on the loading device prior to the lowering of the fuel element into the fuel element container or on pick-up of the fuel element at the beginning of the lifting movement. If a centring bell is present, as described above, the basic load is preferably determined prior to the lifting of the centring bell in the case of the lifting operation and after the placement of the centring bell in the case of the lowering operation. The loading device can further be designed to determine the amount by which the load exceeds or falls below the previously determined basic load and to output that amount as a value, for example by deducting the basic load from the total weight force being measured at the time.

In accordance with an advantageous configuration of the method according to the invention, the closed-loop control of the speed of travel during lifting is effected in accordance with a predefined lifting speed/load profile. This offers the advantage of being able to control the lifting speed in dependence upon the load in accordance with a known lifting speed/load profile.

In accordance with a further advantageous configuration of the method according to the invention, the closed-loop control of the speed of travel during lowering is effected in accordance with a predefined lowering speed/load profile. Analogously to the unloading operation with a predefined lifting speed/load profile, the use of a lowering speed/load profile offers the same above-described advantages as for the loading operation, with the sole difference that the lowering speed is controlled in dependence upon the load in accordance with a known lowering speed/load profile.

In accordance with a further advantageous configuration of the method according to the invention, the lifting along the path of travel is effected at a first lifting speed if the load currently being measured is less than or equal to a predefined upper load limit value and/or if the load change currently being measured is less than or equal to a predefined load change limit value, and at a second lifting speed which is reduced with respect to the first lifting speed, especially other than zero, if the current measured load is greater than the predefined upper load limit value and/or if the current measure load change is greater than the predetermined load change limit value. For example, the first lifting speed can be 3 m/min and the second lifting speed which is reduced with respect to the first lifting speed can be 0.7 m/min.

The use of a predefined upper load limit value or load change limit value, from which the speed is reduced, has the advantage that from a load which may indicate a potential problem during unloading, the speed is reduced in order to facilitate any stopping of the unloading operation, especially for the case where the load continues to increase during the unloading operation. Furthermore, in the case of touching or snagging of adjacent fuel elements, a lesser degree of damage would be expected at a lower speed of travel. In accordance with a further advantageous configuration of the method according to the invention, the upper load limit value is between 500 N and 1000 N, especially between 600 N and 800 N, above the basic load [=weight force that corresponds to the mass of the fuel element to be lifted or lowered and the mass of the parts of the loading device located between load-measuring device and fuel element]. In other words: a limit value for an overload or additional load above the basic load can be between 500 N and 1000 N, especially between 600 N and 800 N.

In accordance with a further advantageous configuration of the method according to the invention, the lifting is stopped if the load currently being measured during lifting is greater than a predefined maximum load.

The introduction of a further limit value, namely the limit value for the maximum load at which the lifting is not only slowed but stopped, has the advantage that it is possible to use empirical values from which it is highly likely that problems will arise during the lifting operation. In comparison with an incremental reduction of the speed of travel from the predefined upper load limit value, the stopping of the lifting from a maximum load offers the advantage of a quicker reaction to any potential problem. In accordance with a further advantageous configuration of the method according to the invention, the maximum load is between 700 N and 1500 N, especially between 800 N and 1200 N, above the basic load.

In accordance with a further advantageous configuration of the method according to the invention, the lowering along the path of travel is effected at a first lowering speed if the load currently being measured is greater than or equal to a predefined lower load limit value and/or if the load change currently being measured is less than or equal to a predefined load change limit value, and at a second lowering speed which is reduced with respect to the first lowering speed, especially other than zero, if the current measured load is less than the predefined lower load limit value and/or if the current measured load change is greater than the predefined load change limit value. The use of a predefined lower load limit value or load change limit value during the loading operation, from which limit value the speed is reduced, offers the analogous advantages for the use of the predefined upper load limit value for the load, from which the speed is reduced during the unloading operation. Unlike the unloading operation, however, during the loading operation friction (due to touching) or snagging of adjacent fuel elements would lead to a reduction in the load. In accordance with an advantageous configuration of the method according to the invention, the lower load limit value can be given by the basic load minus an amount between 500 N and 1000 N, especially between 600 N and 800 N. In other words: a limit value for an underload below the basic load can be between 500 N and 1000 N, especially between 600 N and 800 N. Analogously to the lifting, the first lowering speed can be 3 m/min and the second lowering speed which is reduced with respect to the first lowering speed can be 0.7 m/min.

In accordance with a further advantageous configuration of the method according to the invention, the lowering is stopped if the load currently being measured is less than a predefined minimum load. The introduction of a further limit value, namely the limit value for the minimum load at which the lifting is not only slowed but stopped, offers the analogous advantages to the introduction of the maximum load at which the lifting is not only slowed but stopped. In accordance with a further advantageous configuration of the method according to the invention, that minimum load can be between 700 N and 1500 N, especially between 800 N and 1200 N, below the basic load.

In accordance with an advantageous configuration of the method according to the invention, during lifting and/or lowering the load being measured is measured in dependence upon the position of the fuel element along the path of travel. In addition, during the lifting and/or lowering, the unloading and unloading sequences, that is to say the order in which the individual fuel elements are loaded, can also be detected.

The measurement of the load being measured during lifting and/or lowering in dependence upon the position of the fuel element along the path of travel and unloading and loading sequences has the advantage that it is thereby possible to collect empirical values which can serve as reference for future lifting and lowering operations. In particular, it is to be expected that snagging or touching of the spacers or fuel elements is likely to occur at particular positions along the path of travel, which can be identified with this kind of measurement.

Accordingly, the predefined lifting speed/load profile or the predefined lowering speed/load profile can be optimised on the basis of known information so that any damage during the lifting of the load can be avoided. The lifting speed/load profile and the lowering speed/load profile can especially be optimised by the introduction of previous experiences, calculations or similar information so that where values for the load suggest snagging or touching of adjacent fuel elements, the speed of travel is adjusted. Furthermore, further known parameters, such as, for example, the position of the fuel element in the fuel element container and/or any bowing and twisting of the fuel element that has been detected, can be taken into account in the lifting speed/load profile and the lowering speed/load profile.

In particular, it can be provided that the lifting and/or lowering takes place in a safety zone around a known potential collision region along the path of travel, in which collision region a collision can potentially occur between the fuel element to be lifted or lowered and parts of the fuel element container and/or one or more adjacent fuel elements located in the fuel element container, at a lifting speed or a lowering speed, especially at a reduced third lifting speed or a reduced third lowering speed which is reduced with respect to a lifting speed or a lowering speed, respectively, outside the safety zone. In contrast, the lifting or lowering outside the known potential collision region can be effected at a higher lifting or lowering speed. The lifting speed outside the known potential collision region can preferably correspond to the above-mentioned first lifting speed for a currently measured load lower than or equal to the predefined upper load limit value. Analogously, the lowering speed outside the known potential collision region can preferably correspond to the above-mentioned first lowering speed for a currently measured load greater than or equal to the predefined lower load limit value.

Furthermore, the reduced third lifting speed can preferably correspond to the above-mentioned reduced second lifting speed for a currently measured load greater than the predefined upper load limit value. In the same way, the reduced third lowering speed can correspond to the above-mentioned reduced second lowering speed for a currently measured load lower than the predefined lower load limit value. For example, the reduced third lifting speed and the reduced third lowering speed can be 0.7 m/min.

The one or more known potential collision regions can especially be formed—at least in part—by one or more positions along the path of travel at which one or more spacers of the fuel element to be lifted or lowered, which spacers hold the fuel rods forming the fuel element in position in the fuel element, are located side by side with one or more corresponding spacers of one or more adjacent fuel elements (still or already) located in the fuel element container at substantially the same height along the path of travel and slide over one another during lifting and lowering.

In accordance with an advantageous configuration of the method according to the invention, for each fuel element unloaded from the fuel element container the respective measured load along the path of travel is used to determine a maximum value of the measured load or a maximum value of an overload, that is to say a maximum value by which the measured dynamic load exceeds the basic load [=weight force that corresponds to the mass of the fuel element to be lifted or lowered and the mass of the parts of the loading device located between load-measuring device and fuel element]. Furthermore, each determined maximum value of the measured load or overload during lifting can be shown at a corresponding position of the respective fuel element in a diagram which reproduces the arrangement of the fuel elements in the fuel element container. This allows systematic detection—especially detection that is (immediately) available online—of the positions in the fuel element container which give rise to increased maximum values of the load or overload and, accordingly, at which problems are more likely to occur during the loading/unloading operation. Since the conditions in the fuel element container can be different for the fuel elements at different positions, it is also possible for deformation (especially bowing and/or twisting) of the fuel elements to be dependent upon the position in the fuel element container. The dependence of the deformation upon the position is determined by the distribution of the temperature and the thermohydraulic forces in the fuel element container during operation. Moreover, representation in a diagram makes it possible over the long term to detect the positions which frequently give rise to increased forces. The diagram can serve as a basis for future improvements in the arrangements or the loading/unloading operation.

In accordance with an advantageous configuration of the method according to the invention, for each fuel element that is unloaded or is to be loaded, any bowing of the fuel element transversely with respect to a longitudinal axis of the fuel element and/or any twisting of the fuel element about a longitudinal axis of the fuel element is determined. The bowing and/or twisting of the fuel element increases the likelihood of the fuel elements' touching or snagging during the loading/unloading operation. The deformation of the fuel element so determined can then—preferably together with other data—form the basis for an optimum loading and unloading diagram. For example, in combination with the values for the maximum values of the load or overload along the path of travel it is possible to establish the connection between the maximum value of the load or overload and the deformation of the fuel element.

An especially advantageous configuration of the method according to the invention provides that for further loading and/or unloading of the fuel element container, a position to be occupied in the fuel element container and/or a sequence in which the fuel elements are loaded or unloaded into or from the fuel element container is determined on the basis of the maximum values of the load or overload determined for each unloaded fuel element.

In accordance with an advantageous configuration of the method according to the invention, the determination of the bowing and/or the twisting is effected by optical position measurement of reference points on the outside of the fuel element, the reference points being distributed around the circumference and along the longitudinal axis of the fuel element. By measurement of the position of a plurality of reference points at the above-mentioned points it is possible to create a substantially complete picture of the bowing and possibly twisting of the fuel element which, in combination with empirical values for the dynamic load along the path of travel, in turn provides useful information as to the extent by which a fuel element can be deformed and at which locations, so that trouble-free unloading or loading is still possible.

In accordance with a further advantageous configuration of the method according to the invention, the reference points are located on at least one spacer of the fuel element, which spacer holds the fuel rods forming the fuel element in position in the fuel element. As a result, the reference points are advantageously applied directly to a location on the fuel elements that is critical for the loading und unloading, namely to the spacers. The latter can touch one of the spacers of an adjacent fuel element or can become snagged thereon, especially due to deformation of the fuel element.

In accordance with a further advantageous configuration of the method according to the invention, for further loading and/or unloading of a fuel element into or from the fuel element container, a position to be occupied in the fuel element container and/or a sequence in which the fuel elements are loaded or unloaded into or from the fuel element container is determined on the basis of the bowing and/or twisting determined for the fuel element. This offers the advantage of being able to arrange the fuel elements in the fuel element container in such a way that, as far as possible, adjacent fuel elements do not touch or become snagged during unloading and loading due to their deformation.

In accordance with a further advantageous configuration of the method according to the invention, a lowering speed/path of travel profile for further loading of the fuel element into the fuel element container is determined on the basis of the load currently being measured in dependence upon the position of the fuel element along the path of travel during lifting. The load along the path of travel during loading and unloading of the fuel element is typically dependent upon circumstances such as the deformation of the fuel element to be loaded or unloaded and of the adjacent fuel elements as well as upon the position of the spacers on the fuel element. By creating a lowering speed/path of travel profile for further loading of the fuel element into the fuel element container it is advantageously possible to adjust the speed for the next loading operation at the critical positions along the path of travel in accordance with the circumstances.

In accordance with an advantageous configuration of the method according to the invention, the fuel element is investigated for any damage caused during unloading on the basis of the load currently being measured in dependence upon the position of the fuel element along the path of travel during lifting and/or on the basis of the bowing and/or twisting determined for the fuel element. This offers the advantage that the investigation of the fuel element for any damage is focused specifically on the locations of the fuel element where damage to the fuel element is most likely. These are typically, on the one hand, locations which give rise to an increased load during unloading and, on the other hand, locations which have significant deformation. As a result, the investigation of the fuel element can be optimised and accordingly, once again, time can be saved.

In the same way, the fuel element container, especially if it is a fuel element compact storage facility, wet storage facility, a transport container, or a transport and storage container, can also be investigated for any damage caused during unloading on the basis of the load currently being measured in dependence upon the position of the fuel element along the path of travel during lifting and/or on the basis of the bowing and/or twisting determined for the fuel element.

The singular forms “a/an” and “the” used in the patent description, including the claims, also include the corresponding plural unless indicated to the contrary. If features of the invention are combined with the expression “or”, then the expression “or” also includes “and”, except where it is apparent from the description that the expression “or” needs to be interpreted as exclusive.

The method according to the invention is described in greater detail below with reference to exemplary embodiments shown in the drawings, wherein:

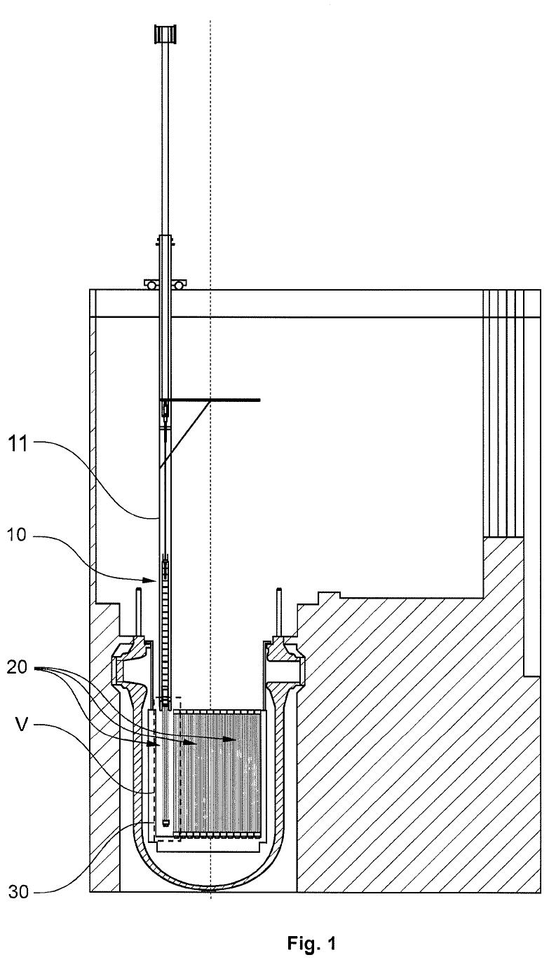

FIG. 1 is a diagrammatic representation of the unloading or loading of a fuel element from or into a reactor pressure vessel in accordance with the method according to the invention;

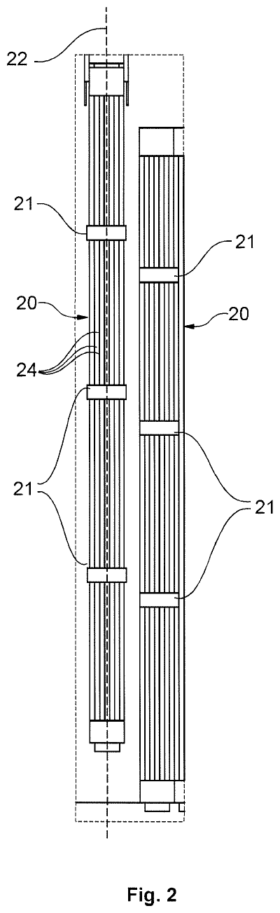

FIG. 2 is a detail view of the unloading or loading operation according to FIG. 1;

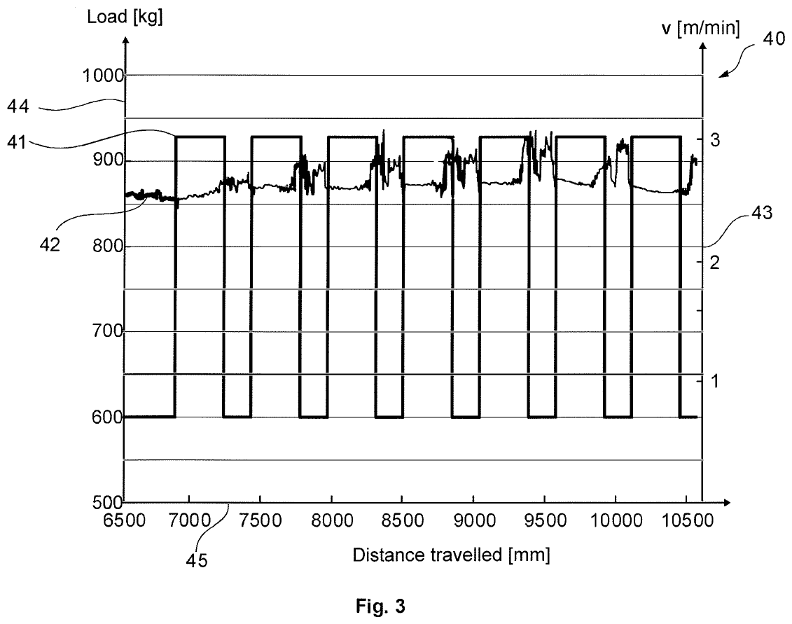

FIG. 3 is a graph showing a load-dependent speed adjustment during the unloading operation in accordance with an exemplary embodiment of the method according to the invention; and

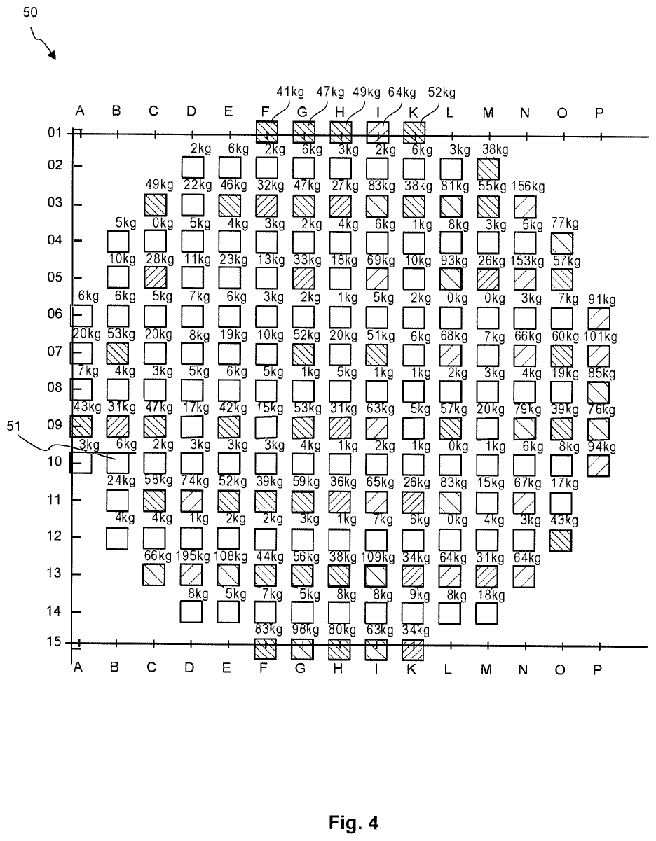

FIG. 4 is a diagrammatic representation of an arrangement of the fuel elements in the reactor pressure vessel with an associated maximum value of a measured overload during the lifting of a fuel element out of the fuel element container.

The following observations apply in respect of the description which follows: where, for the purpose of clarity of the drawings, reference symbols are included in a Figure but are not mentioned in the directly associated part of the description, reference should be made to the explanation of those reference symbols in the preceding or subsequent parts of the description. Conversely, to avoid overcomplication of the drawings, reference symbols that are less relevant for immediate understanding are not included in all Figures. In that case, reference should be made to the other Figures.

FIG. 1 shows an operation of unloading or loading a fuel element 20 from or into a fuel element container 30 according to an exemplary embodiment of the method according to the invention, wherein the fuel element container 30 is a reactor pressure vessel 30. FIG. 2 shows an enlarged view of the detail V marked with dashed lines in FIG. 1.

As shown in FIG. 1, in the reactor pressure vessel 30 there are located a plurality of fuel elements 20 which are arranged in an upright position one next to the other and a small distance apart from one another. As FIG. 2 shows in detail, each of the fuel elements consists of assemblies of fuel rods 24 which are held together in the assembly by means of spacers 21. The spacers 21 are typically mounted at a plurality of locations in the longitudinal direction of the fuel element 20. The number and exact position of the spacers on the fuel element 20 can vary.

During operation, the temperatures in the reactor pressure vessel 30, especially in the fuel rods 24, are very high, which can result in bowing or twisting with respect to a longitudinal axis 22 of the fuel elements 20. The bowing can have the effect that the spacers 21 are displaced relative to the longitudinal axis 22 of the fuel element 20. Twisting of the fuel element 20 can have the effect that the upper and lower ends of the fuel elements 20 are twisted relative to one another. In particular, the spacers 21, which have a substantially rectangular outer profile in plan view, can be twisted relative to one another. Due to the twisting and the bowing of the fuel elements 20, the lateral ends of the spacers 21 can project further from the longitudinal axis 22 of the fuel element 20 than intended, with the result that the overall amount of space required for a fuel element 20 in the transverse direction (perpendicular to the longitudinal axis) can increase. As a result, it can be that the spacing of the fuel elements 20 from one another is reduced in certain regions of the fuel element 20, especially in the region of the spacers 21, or, in some cases, adjacent fuel elements 20 even touch.

For maintenance or exchange of the fuel elements 20, the fuel elements 20 are loaded or unloaded from the reactor pressure vessel 30. For the loading operation, the fuel element 20 is lowered into its designated position in the reactor pressure vessel 30 by means of the loading device 10. For that purpose, a fuel element 20 is grasped at its upper end by means of a gripper arm 11 and moved by the loading device 10 into its intended position in the reactor pressure vessel 30 and lowered by the gripper arm 11. Deformation of the fuel elements 20 can mean that, despite being correctly positioned, the fuel elements 20 are not located at a predetermined spacing from one another at all locations along the longitudinal direction of the fuel elements 20. Particularly at the locations on the fuel element 20 at which the spacers 21 are located, it can happen that the said deformation makes it impossible to adhere to the specified spacing. As a result, adjacent fuel elements 20, especially the spacers 21, may touch or become snagged during the loading operation. Snagging leads to a reduction in the total load on the loading device 10 in a vertical direction.

Correspondingly, during the unloading operation the fuel element 20, which is located at the designated position in the reactor pressure vessel 30, is grasped with the gripper arm 11 and lifted out of the reactor pressure vessel 30. Deformation, chiefly twisting and bowing, can also result in the spacers 21 touching or snagging during the unloading operation. In that case the touching or snagging leads to an increase in the total load on the loading device 10.

The loading device 10 is equipped with a load-measuring device which detects the dynamic load along the path of travel. For that purpose, by means of the load-measuring device the dynamic load acting vertically downwards is detected, preferably substantially continuously (in order, if necessary, to initiate an overload cut-off) and, at short intervals, recorded and stored, for example with 3 measured values per millimetre of lifting or lowering movement. The intervals between the measurement points are chosen to be small enough to provide sufficient data for an analysis of any problems during unloading or loading, especially for the identification of load peaks. The load-measuring device is a force sensor which detects the dynamic load and/or load change acting on the loading device 10 on the basis of the measured force. The measured load and/or load change is instantaneously displayed to the operator and transmitted to a feedback loop for closed-loop control of the speed of travel. Furthermore, the measured load is stored together with the distance covered at each timepoint.

That is to say, during loading and unloading, the load and/or change in the load on the loading device along the vertical direction during the unloading or loading operation is measured. Furthermore, according to the invention the speed of travel, that is to say the speed with which the fuel element 10 is moved in a vertical direction by the lifting and lowering device, can be controlled in dependence upon the measured load, manually or by the feedback loop.

FIG. 3 shows a graph of the dynamic load (curve 42) during unloading as a function of the distance travelled. The distance travelled is shown on the x-axis 45 (in mm) in a region in which the spacers can touch fuel elements 20. Also shown in the graph is the speed of travel adjusted in accordance with the load (curve 41) in m/min during the lifting of the fuel element (axis 43) and the load as a function of the distance travelled (axis 44). In the case of the load, the value corresponding to a weight in kg is shown. In the case of a load above a predefined upper load limit value for the load, the lifting speed is reduced from a first value to a second lifting speed which is reduced with respect to the first lifting speed. Correspondingly, the lifting speed is increased again if the measured load falls below the upper load limit value again.

Furthermore, it can be seen in the graph how the lifting speed is reduced in the case of higher values for the load and correspondingly increased in the case of lower values for the load. In the present example, the upper load limit value is between 500 N and 1000 N, especially between 600 N and 800 N, above the basic load, that is to say above the weight force that corresponds to the mass of the fuel element to be lifted or lowered and the mass of the parts of the loading device located between load-measuring device and fuel element. The method can furthermore be expanded so that, during lifting, from a maximum load the speed of travel is not only reduced but completely stopped. The maximum load is, for example, between 700 N and 1500 N, especially between 800 N and 1200 N, above the basic load.

The method can be also used correspondingly for the loading. During loading, however, touching or snagging of the spacers 21 of adjacent fuel elements 20 has the effect that the force acting on the loading device decreases instead of—as in the case of unloading—increasing. Accordingly, the lowering is effected at a second lowering speed which is reduced with respect to a first lowering speed if the load falls below a lower load limit value. The lower load limit value is, for example, between 500 N and 1000 N, especially between 600 N and 800 N, below the basic load. Analogously to the unloading operation, in the case of the loading operation it is likewise possible to introduce a limit value, from which the lowering is stopped. That limit value is, for example, between 700 N and 1500 N, especially between 800 N and 1200 N, below the basic load.

The possibility of measuring the load online and creating a speed of travel/load profile in dependence upon the position on the path of travel, as well as the adjustment of the speed of travel to the load currently being measured, allows a large number of possible ways of optimising the unloading and loading process. In an exemplary embodiment, it is possible to create a lowering speed/path of travel profile on the basis of the load measured along the path of travel during lifting, which profile can advantageously be used for further loading of the fuel element 20 into the reactor pressure vessel 30. Since the problems during unloading are caused chiefly by deformation of the fuel elements 20, it is to be expected that during the loading operation analogous problems will occur at the same positions along the path of travel as in the case of the unloading operation. Consequently, the load measured along the path of travel during lifting can also be used for a corresponding lowering speed/path of travel profile for the lowering of the fuel element 20.

In particular, it can be provided that the lifting and/or lowering takes place in a safety zone around a known potential collision region along the path of travel, in which collision region a collision can potentially occur between the spacers of the fuel element to be lifted or lowered and the spacers of the adjacent fuel elements (already or still) located in the fuel element container, at a reduced third lifting speed or a reduced third lowering speed, respectively. In contrast, the lifting or lowering outside the known potential collision region can take place at a higher lifting or lowering speed. This is shown in FIG. 3, in which it can be seen how, during lifting, the speed curve 41 alternates between the first and third lifting speeds corresponding to the positions of the spacers and the occurrence of the potential collision region.

A further possible way of optimising the unloading process is based on the creation of a diagram for the load during unloading of the fuel elements 20, the diagram reproducing the arrangement of the fuel elements 20 in the reactor pressure vessel 30. Such a diagram 50 is shown in FIG. 4. The diagram shows in diagrammatic form the arrangement of the fuel elements 20 in the reactor pressure vessel 30 in plan view. Each of the squares 51 corresponds to the position of a fuel element 20. The loads shown correspond to the maximum overload on the loading device for the respective fuel element 20, that is to say the maximum amount by which the measured dynamic load exceeds the basic load. The maximum overload is shown as a weight corresponding to the force minus the mass of the fuel element 20. A corresponding diagram can also be created for the loading operation, the diagram showing the maximum underload, that is to say the maximum amount by which the measured dynamic load falls below the basic load, for the respective fuel element 20 at its position in the reactor pressure vessel. For further loading and/or unloading of the fuel element container it is then possible for a position to be occupied in the fuel element container 30 and/or a sequence in which the fuel elements 20 are loaded into or unloaded from the fuel element container 30 to be determined on the basis of the maximum values of the load or overload determined for each unloaded fuel element 20.

Comparable diagrams can be created not only for the measured maximum overload or underload along the path of travel, but also for further relevant measurement variables, such as, for example, the twisting or bowing of the fuel element. With the aid of such a diagram it is possible to adjust future loading and unloading processes accordingly, for example so that in future loading processes the position of the fuel element 20 to be loaded in the reactor pressure vessel 30 and/or a sequence in which the fuel elements 20 are loaded into or unloaded from the fuel element container 30 is specified. As a result, for example, two fuel elements 20 having a relatively high degree of deformation can be prevented from being located directly one next to the other in the reactor pressure vessel 30 or are less likely to touch or snag the spacers.

Since the described difficulties are chiefly brought about by deformation of the fuel elements 20, it is advantageous to measure the fuel elements 20 for deformation. For that purpose, the twisting or bowing is determined by optical position measurement of reference points on the outside of the fuel element 20, the reference points being distributed around the circumference and along the longitudinal axis 22 of the fuel element 20. Such “straightness measurement”, as it is known, is typically effected in an inspection stand having a camera system. Since the deformation of the fuel element in the region of the spacers 21 is of particular interest, it is advantageous for at least one of the reference points to be located on at least one of the spacers 21.

1. A method for load-dependent unloading and/or loading of a fuel element from or into a fuel element container, especially a reactor pressure vessel, by means of a loading device, wherein the loading device is designed to lift a fuel element out of the fuel element container or to lower it into the fuel element container along a path of travel at a variable speed of travel, the loading device having a load-measuring device for online measurement of a dynamic load and/or load change acting at the time on the loading device along the path of travel during lifting or lowering of the fuel element, the speed of travel during lifting or lowering of the fuel element being subject to closed-loop control in dependence upon the load and/or load change being measured at the time.

2. The method according to claim 1, wherein the closed-loop control of the speed of travel during lifting is effected in accordance with a predefined lifting speed/load profile, and/or wherein the closed-loop control of the speed of travel during lowering is effected in accordance with a predefined lowering speed/load profile.

3. The method according to claim 1, wherein the lifting along the path of travel is effected at a first lifting speed if the load currently being measured is less than or equal to a predefined upper load limit value and/or if the load change currently being measured is less than or equal to a predefined load change limit value, and at a second lifting speed which is reduced with respect to the first lifting speed if the current measured load is greater than the predefined upper load limit value and/or if the current measured load change is greater than the predefined load change limit value.

4. The method according to claim 1, wherein the lowering along the path of travel is effected at a first lowering speed if the load currently being measured is greater than or equal to a predefined lower load limit value and/or if the load change currently being measured is less than or equal to a predefined load change limit value, and at a second lowering speed which is reduced with respect to the first lowering speed if the current measured load is less than the predefined lower load limit value and/or if the current measured load change is greater than the predefined load change limit value.

5. The method according to claim 1, wherein the lifting is stopped if the load currently being measured during lifting is greater than a predefined maximum load: and/or wherein the lowering is stopped if the load currently being measured is less than a predefined minimum load.

6. The method according to claim 1, wherein the lifting and/or lowering takes place in a safety zone around a known potential collision region along the path of travel, in which collision region a collision can potentially occur between the fuel element to be lifted or lowered and parts of the fuel element container and/or one or more adjacent fuel elements located in the fuel element container, at a lifting speed or a lowering speed which is reduced with respect to a lifting speed or a lowering speed, respectively, outside the safety zone.

7. The method according to claim 6, wherein one or more known potential collision regions are formed at least in part by one or more positions along the path of travel at which one or more spacers of the fuel element to be lifted or lowered, which spacers hold the fuel rods forming the fuel element in position in the fuel element, are located side by side with one or more corresponding spacers of one or more adjacent fuel elements located in the fuel element container at substantially the same height along the path of travel.

8. The method according to claim 1, wherein during lifting and/or lowering the load being measured is measured in dependence upon the position of the fuel element along the path of travel.

9. The method according to claim 1, wherein for each fuel element unloaded from the fuel element container the respective measured load along the path of travel is used to determine a maximum value of the measured load or a maximum value of an overload.

10. The method according to claim 9, wherein each determined maximum value of the measured load or the maximum value of an overload during lifting is shown at a corresponding position of the respective fuel element in a diagram which reproduces the arrangement of the fuel elements in the fuel element container.

11. The method according to claim 9, wherein for further loading and/or unloading of the fuel element container, a position to be occupied in the fuel element container and/or a sequence in which the fuel elements are loaded or unloaded into or from the fuel element container is determined on the basis of the maximum values of the load or overload determined for each unloaded fuel element.

12. The method according to claim 1, wherein for each fuel element that is unloaded or is to be loaded, any bowing of the fuel element transversely with respect to a longitudinal axis of the fuel element and/or any twisting of the fuel element about a longitudinal axis of the fuel element is determined.

13. The method according to claim 12, wherein for further loading and/or unloading of a fuel element into or from the fuel element container, a position to be occupied in the fuel element container and/or a sequence in which the fuel elements are loaded or unloaded into or from the fuel element container is determined on the basis of the bowing and/or twisting determined for the fuel element.

14. The method according to claim 1, wherein a lowering speed/path of travel profile for further loading of the fuel element into the fuel element container is determined on the basis of the load currently being measured in dependence upon the position of the fuel element along the path of travel during lifting.

15. The method according to claim 1, wherein the fuel element is investigated for any damage caused during unloading on the basis of the load currently being measured in dependence upon the position of the fuel element along the path of travel during lifting and/or on the basis of the bowing and/or twisting determined for the fuel element.
